(19) United States
(12) Patent Application Publication
(10) Pub. No.: US 2024/0025045 A1
(43) Pub. Date: Jan. 25, 2024

(54) CONTROL DEVICE FOR INDUSTRIAL MACHINE

(71) Applicant: FANUC CORPORATION, Yamanashi (JP)

(72) Inventor: Kazuki ISHIMOTO, Yamanashi (JP)

(73) Assignee: FANUC CORPORATION, Yamanashi (JP)

(21) Appl. No.: 18/044,016

(22) PCT Filed: Sep. 24, 2021
(86) PCT No.: PCT/JP2021/035035

§ 371 Date: Mar. 3, 2023

(30) Foreign Application Priority Data
Sep. 30, 2020 (JP) 2020-165952

(51) Int. Cl. B25J 9/16

(52) U.S. Cl. CPC B25J 9/1674

(57) ABSTRACT

A control device 10 for an industrial machine acquires a control deviation CD concerning the motion of a predetermined mechanism section 4, acquires detected temperature data DT of the mechanism section 4 if the control deviation CD is greater than a predetermined first threshold Th1, and outputs alarm information including a message urging improvement of an operating condition if the detected temperature data DT is less than a second threshold Th2. Thus, the fact that an abnormal motion alarm related to the predetermined mechanism part 4 was caused by a low temperature is notified, and a necessary operating condition improvement is urged.

### TECHNICAL FIELD

The present invention pertains to a control device for an industrial machine.

### BACKGROUND ART

A control device for an industrial machine such as a robot calculates a control deviation based on the difference between a movement command to a motor in a mechanism section and an amount of movement that is a feedback value from the motor. This control deviation is compared with a predefined threshold and used in abnormal operation detection for the robot. Upon detecting abnormal motion by the robot, the control device causes an alarm to be generated to thereby cause the robot to stop. Note that, there is a past technical proposal for adding temperature measurement data to a record of the occurrence of an error due to operation by a robot (for example, refer to Patent Document 1). In addition, there is a technical proposal for monitoring a damage situation for a speed reducer in a robot (for example, refer to Patent Document 2). There is also a technical proposal for a robot control device that enables a robot to continue operation at a constant speed even if a lubricating oil temperature for a speed reducer in the robot fluctuates (for example, refer to Patent Document 3).

### PRIOR ART REFERENCE

### Patent Document

Patent Document 1: Japanese Unexamined Patent Application, Publication No. 2019-150923
Patent Document 2: Japanese Unexamined Patent Application, Publication No. 2013-244564
Patent Document 3: Japanese Unexamined Patent Application, Publication No. H8-126369

### DISCLOSURE OF THE INVENTION

### Problems to be Solved by the Invention

In a robot such as an industrial robot, a lower limit on a low-temperature side for an environment in which the robot is used is typically approximately 0 degrees Celsius. The viscosity of a lubricant (grease) used in a speed reducer in a robot changes in accordance with temperature, and there is a tendency for the viscosity to rise in a low-temperature environment. Accordingly, the lubricant hardens at a time when the outside temperature drops, whereby a load for a case of driving a mechanism section increases. Accordingly, motor trackability worsens, and a control deviation pertaining to motion by the mechanism section increases. In such a low-temperature environment, even if a robot is performing the same motion, there are cases where an abnormal motion alarm is generated and cases where an abnormal motion alarm is not generated, depending on the outside temperature. Accordingly, there is a problem that a cause why an abnormal motion alarm was generated is difficult to understand for a user. However, none of the abovementioned Patent Documents describe a means for solving such a technical problem.

Accordingly, there is a desire for a device for which a notification is made for an abnormal motion alarm that pertains to a predetermined mechanism section and is due to a low temperature, and a prompt to improve a required operation condition is made.

### Means for Solving the Problems

A control device for an industrial machine according to one aspect of the present disclosure includes: a control deviation acquisition unit configured to obtain a control deviation pertaining to motion by a predetermined mechanism section; a temperature information acquisition unit configured to obtain temperature information for the mechanism section in a case where the control deviation obtained by the control deviation acquisition unit is greater than a predetermined first threshold; a comparing unit configured to compare a value in accordance with the temperature information obtained by the temperature information acquisition unit with a predetermined second threshold; and an alarm information output unit configured to, in a case where the value in accordance with the temperature information is less than the second threshold, output alarm information including a message having a gist of prompting improvement of an operation condition.

### Effects of the Invention

By virtue of one aspect, it is possible to identify that an abnormal motion alarm pertaining to a predetermined mechanism section is due to a low temperature, and improving a required operation condition is recognized.

### BRIEF DESCRIPTION OF THE DRAWINGS

FIG. 1 is a view that illustrates a control device for an industrial machine and a robot which is a control target, according to the present disclosure;

FIG. 2 is a view that illustrates a state in which a temperature sensor is provided for a speed reducer in the robot in FIG. 1;

FIG. 3 is a view that illustrates a state in which a temperature sensor is provided in a motor in the robot in FIG. 1;

FIG. 4 is a view for describing a method for estimating the temperature of a mechanism section in the robot in FIG. 1; and

FIG. 5 is a flow chart that illustrates an example of a process executed by the control device that is for an industrial machine and is in FIG. 1.

### PREFERRED MODE FOR CARRYING OUT THE INVENTION

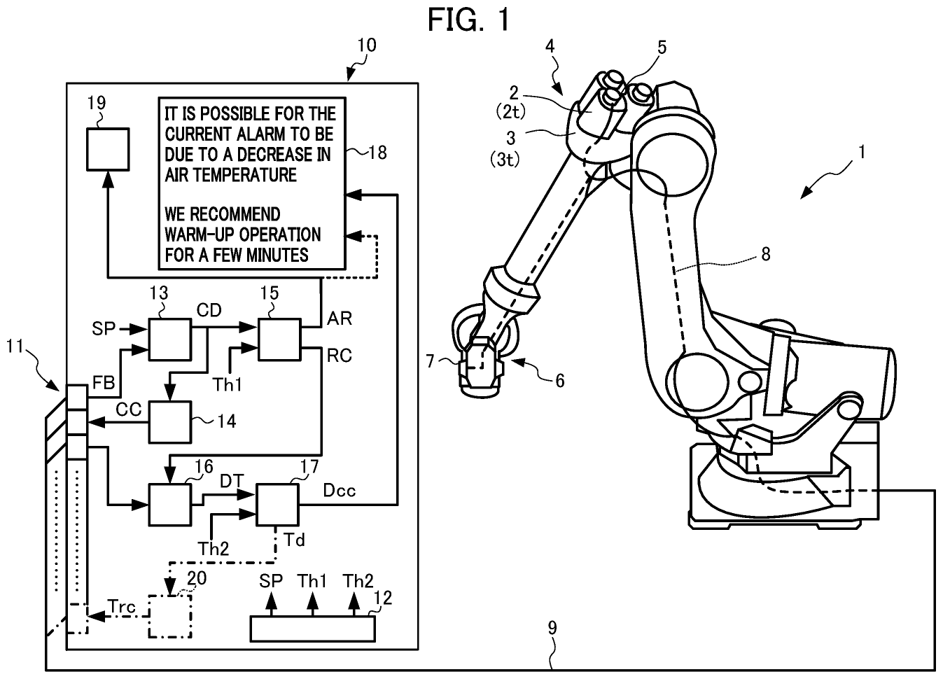

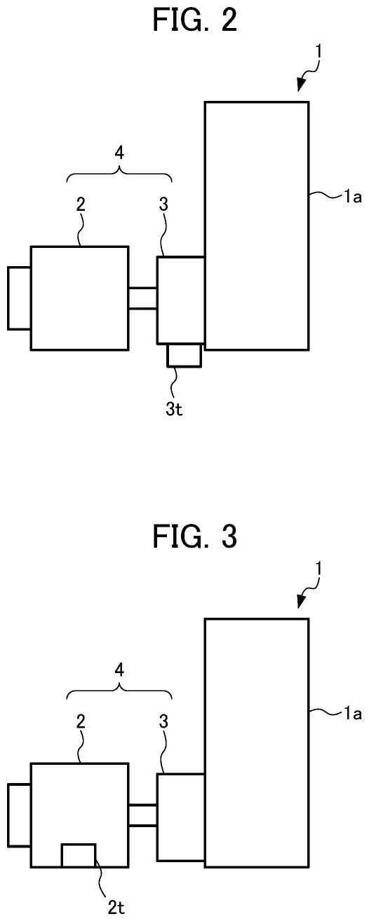

FIG. 1 is a view that illustrates a control device for an industrial machine and a robot which is a control target, according to the present disclosure. In FIG. 1, a robot 1 has a mechanism section 4 that is configured by including a motor 2 and a speed reducer 3. A motor temperature sensor 2t and an encoder 5 that encodes and outputs a rotation amount for a shaft are attached to the motor 2. A speed reducer temperature sensor 3t is attached to the speed reducer 3. In addition, a motion angle sensor 7 that detects a bending angle is provided on a wrist section 6 belonging to a robot arm. Detected temperature data DT in accordance with the motor temperature sensor 2t or the speed reducer temperature sensor 3t and output data from the encoder 5 or the motion angle sensor 7 are guided from a cable 8 going through the robot 1 to, via a connector (not shown) for an external connection, the control device 10 using an external cable 9. Note that, in addition to the various items of data described above, a later-described control command CC, various items of detection data, etc. are sent and received between the robot 1 and the control device 10 through the cable 8 and the cable 9. The configuration given above in which the speed reducer temperature sensor 3t is provided in the speed reducer 3 is one aspect, and is exemplified in FIG. 2 described below. In addition, a configuration in which the motor temperature sensor 2t is provided in the motor 2 is another aspect, and is exemplified in FIG. 3 described below.

Various conductors (core wires) in the cable 9 are connected to an external connection terminal 11 in the control device 10. FIG. 1 represents, as a functional block diagram, an internal configuration for the control device 10 with respect to the external connection terminal 11. A portion expressed as a functional block diagram is realized by executing an application program stored in a memory in hardware such as a microcomputer or a peripheral device (not shown). In addition, there is no limitation to this, and realization may be by collaboration between hardware (an electronic circuit) and software. A target value (command value) SP supplied from a reference data generating unit 12, which is an illustrated functional unit, and a feedback value FB are supplied to a control deviation acquisition unit 13. The control deviation acquisition unit 13 acquires data for a control deviation CD which corresponds to the difference between the command value SP and the feedback value FB.

In this case, the command value SP is a value pertaining to a rotation amount for the motor 2 in one mechanism section 4 in the robot 1, or a bending angle for the wrist section 6 in the robot arm, which is another mechanism section. A feedback value FB corresponding to these is output data from the encoder 5 or the motion angle sensor 7, and is supplied from the robot 1 to the control deviation acquisition unit 13 in the control device 10 through the cables 8 and 9. The control deviation acquisition unit 13 acquires the control deviation CD as the difference between the command value SP and the feedback value FB described above. The control deviation CD pertains to a rotation amount by the motor 2 in the mechanism section 4 which corresponds to one mechanism section in the robot 1, or pertains to a bending angle pertaining to the wrist section 6 which is another mechanism section. The control deviation CD is supplied to a control command forming unit 14. The control command forming unit 14 generates command data that is the control command CC that corresponds to the control deviation CD and, through the cable 9, supplies the command data to, inter alia, the motor 2 which is a corresponding actuator in the robot 1.

Meanwhile, the control deviation CD obtained by the control deviation acquisition unit 13 is also supplied to a first comparing unit 15. A first threshold Th1 generated from the reference data generating unit 12 is supplied to the first comparing unit 15. The first comparing unit 15 compares the supplied control deviation CD with the first threshold Th1. In a case where the control deviation CD is greater than the first threshold Th1 as a result of this comparison, the first comparing unit 15 supplies a temperature data read command RC to a temperature data sampling unit 16.

In response to the temperature data read command RC, the temperature data sampling unit 16 reads detected temperature data DT from the motor temperature sensor 2t or the speed reducer temperature sensor 3t in the robot 1, through the cable 8 and the cable 9. The detected temperature data DT read by the temperature data sampling unit 16 is supplied to a second comparing unit 17. In addition, a second threshold Th2 generated from the reference data generating unit 12 is supplied to the second comparing unit 17. The second comparing unit 17 compares a value for the detected temperature data DT with the second threshold Th2. In the case where the value for the detected temperature data DT is less than the second threshold Th2, the second comparing unit 17 supplies a display control command Dcc to a display unit 18. Note that, in a case where a value for the detected temperature data DT is equal to or greater than the second threshold Th2, the second comparing unit 17 supplies to the display unit 18 a display control command Dcc having content that differs to the case where the value for the detected temperature data DT is less than the second threshold Th2. The display unit 18 displays information that corresponds to the display control command Dcc.

Meanwhile, in a case where the control deviation CD is greater than the first threshold Th1, the first comparing unit 15 supplies an alarm issuance command AR to an alarm issuing unit 19. Upon receiving the alarm issuance command AR, the alarm issuing unit 19 issues an alarm in accordance with a warning sound, light emission, etc. Issuance of an alarm in the alarm issuing unit 19 can be stopped in response to an operation by a user (operator) with respect to an alarm stop operation unit (not shown). Note that it may be that configuration is made to also supply the alarm issuance command AR from the first comparing unit 15 to the display unit 18, and issue an alarm together with the display unit 18 displaying information that corresponds to the display control command Dcc.

Here, as one aspect, it is possible to employ a configuration in which, in a case where the value for the detected temperature data DT is less than the second threshold Th2, the above-described second comparing unit 17 generates temperature difference data Td corresponding to the difference (the absolute value thereof) between the value for the detected temperature data DT and the second threshold Th2. In a case where this aspect is employed, the temperature difference data Td generated by the second comparing unit 17 is supplied to a warm-up operation control unit 20. The warm-up operation control unit 20 generates a warm-up operation control command Trc that corresponds to the supplied temperature difference data Td. This warm-up operation control command Trc is transmitted to a warm-up operation means in the robot 1 through the cable 9 and the cable 8, and warm-up operation that corresponds to the warm-up operation control command Trc is performed on the robot 1 side. Note that the warm-up operation means on the robot 1 side can be configured by, inter alia, the motor 2. In other words, it is possible to achieve a mode for causing the viscosity of a lubricant to decrease by performing warm-up operation for a certain amount of time before full-scale operation of the motor 2 and the mechanism section 4. Note that the warm-up operation means may be a heater.

FIG. 2 is a view that illustrates a state in which a temperature sensor is provided for the speed reducer in the robot in FIG. 1. The mechanism section 4 drives one robot arm 1a belonging to the robot 1 and is configured by including the motor 2 and the speed reducer 3 that transmits a driving force for this motor 2 to the robot arm 1a. The speed reducer temperature sensor 3t is provided at a predetermined site on the speed reducer 3. A detection output from the speed reducer temperature sensor 3t is transmitted to the control device 10 through the cables 8 and 9 that are in FIG. 1.

FIG. 3 is a view that illustrates a state in which a temperature sensor is provided in a motor in the robot in FIG. 1. The mechanism section 4 drives one robot arm 1a belonging to the robot 1 and is configured by including the motor 2 and the speed reducer 3 that transmits a driving force for this motor 2 to the robot arm 1a. The motor temperature sensor 2t is provided at a predetermined site in the motor 2. In a case where the type of the motor 2 is something that has a temperature sensor, this temperature sensor may be used as the motor temperature sensor 2t. A detection output from the motor temperature sensor 2t is transmitted to the control device 10 through the cables 8 and 9 that are in FIG. 1.

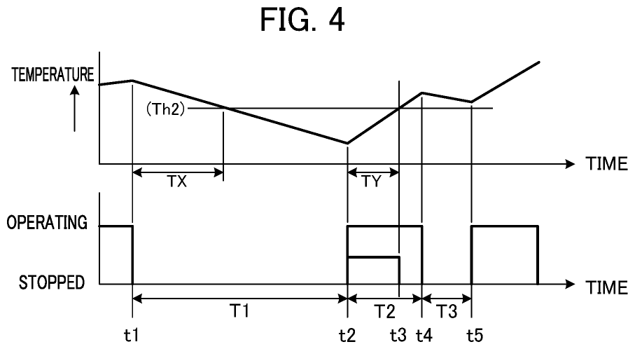

FIG. 4 is a view for describing a method for estimating the temperature of a mechanism section in the robot in FIG. 1. A lower portion in FIG. 4 illustrates a situation in which operation by the robot 1 and a stop state switch over time. An upper portion in FIG. 4 illustrates change over time for the temperature of the mechanism section in the robot, in correspondence with the lower portion in FIG. 4. Note that, when the robot 1 is in an operational state, the mechanism section 4 (motor 2 and speed reducer 3) is continuously or periodically continuing operation. In addition, when the robot 1 is in a stopped state, the mechanism section 4 (motor 2 and speed reducer 3) is not continuously or periodically continuing operation.

Referring to the lower portion in FIG. 4, the robot 1 stops at a time t1, and subsequently the robot 1 resumes operation at a time t2 after a time period T1 has elapsed. The robot 1 continues operation until a time t4, which is when a time period T2 has elapsed since the robot 1 shifted to the operational state at time t2, and subsequently stops. This time period T2 includes a time t3 at which a time period TY from the time t2 elapsed. The robot 1 continues the stopped state until a time t5, which is when a time period T3 elapsed since the robot 1 shifted to the stopped state at the time t4, and then shifts to the operational state again.

During an operational time period for the robot 1, the temperature of grease, which is a lubricant in the mechanism section 4 (the motor 2 and the speed reducer 3), rises due to heat arising due to friction in the mechanism section 4, and the viscosity of the grease decreases. Accordingly, resistance with respect to motion in the mechanism section gradually decreases and motion becomes easier, and the control deviation CD decreases due to good followability for the feedback value FB with respect to the control command CC pertaining to motion.

Referring to the upper portion in FIG. 4, the temperature of the mechanism section 4 decreases in the time period T1 after the time t1. In conjunction with the decrease of the temperature of the mechanism section 4, the viscosity of the grease in the mechanism section 4 increases, and motion by a movable part becomes slower. Accordingly, the control deviation CD, which pertains to motion by the mechanism section 4 increases, and the followability for control worsens. In the example in FIG. 4, a time period TX elapses from the time t1, and the temperature of the mechanism section 4 drops to a value (Th2) that corresponds to the threshold Th2. In a state where the temperature of the mechanism section 4 has decreased to here and control followability has worsened, an alarm is issued from the alarm issuing unit 19 in FIG. 1. At the time t2 at which the time period T1 exceeding the time period TX has elapsed since the time t1, the robot 1 shifts to the operational state. The temperature of the mechanism section 4 shifts to gradually rise from the time t2, and motion by the mechanism section 4 gradually gets easier in conjunction therewith. Upon reaching the time t3, at which the time period TY has elapsed since the time t2, the temperature of the mechanism section 4 has risen to a value that exceeds the value (Th2) corresponding to the threshold Th2. A value that exceeds the value (Th2) corresponding to the threshold Th2 is a temperature at a level for which an alarm pertaining to the control deviation CD is not issued. Going through this time t3, the temperature of the mechanism section 4 follows a tendency to rise from the time t2 until the time t4, which is the end of the time period T2 during which the operational state continues, is reached. Upon passing the time t4, the robot 1 shifts to the stopped state. The temperature of the mechanism section 4 drops from the time t4. However, at the time t5 which is when the time period T3 shorter than the above-described time period TX has elapsed since the time t4, the robot 1 shifts to the operational state again. Accordingly, although the temperature of the mechanism section 4 gradually decreases over the period from the time t4 until the time t5, the temperature of the mechanism section 4 does not drop to the level of a value (Th2) corresponding to the threshold Th2, and shifts to rising again after the time t5.

From the phenomenon described with reference to FIG. 4, it is possible to estimate the temperature of the mechanism section 4 as follows. In other words, when the robot 1 enters the stopped state and motion by the mechanism section 4 has stopped, it is estimated that the temperature of the mechanism section 4 becomes equal to or less than a value (Th2) corresponding to the threshold Th2 when an amount of time equal to or greater than the time period TX elapses since the time when this motion stopped. In addition, when the robot 1 enters the operational state and the mechanism section 4 starts moving, it is estimated that the temperature of the mechanism section 4 stays equal to or less than the value (Th2) corresponding to the threshold Th2 while within the time period TY since the time when this movement started. In other words, it is possible to estimate the temperature of the mechanism section 4 at the current time from a positional relationship on the time axis between operational and stop timings for the robot 1.

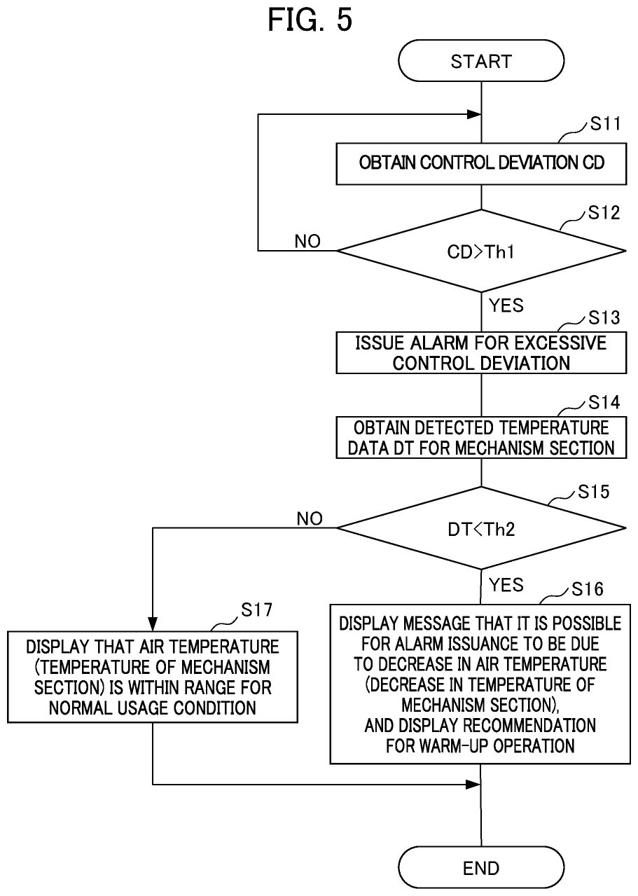

Next, with reference to a flow chart in FIG. 5, description is given regarding a process executed by the control device 10. From among processes executed by the control device 10, the process illustrated in FIG. 5 pertains to, in a case where an alarm that the control deviation is excessive has been issued, functionality for displaying alarm information including a message that it is possible for this alarm to be due to a decrease of the temperature of the mechanism section 4 in accordance with a decrease of the air temperature. A process for each step in FIG. 5 is executed by one or a plurality of functional blocks in the control device 10 in FIG. 1.

When the process is started, the control deviation acquisition unit 13 acquires a control deviation CD for the feedback value FB with respect to the target value (command value) SP (Step S11). Next, the first comparing unit 15 compares the control deviation CD with the first threshold Th1 (Step S12). In a case where the control deviation CD is greater than the first threshold Th1 as a result of this comparison (Step S12: YES), the first comparing unit 15 supplies an alarm issuance command AR to an alarm issuing unit 19. In contrast, in a case where the control deviation CD is equal to or less than the first threshold Th1 as a result of the comparison in the first comparing unit 15 (Step S12: NO), Step S11 is returned to.

Upon receiving the alarm issuance command AR, the alarm issuing unit 19 issues an alarm in accordance with a warning sound, light emission, etc. (Step S13). Note that issuance of an alarm in the alarm issuing unit 19 is issuance with the gist that the control deviation CD is excessive, and can be stopped in response to an operation with respect to the alarm stop operation unit (not shown) by a user (operator). In addition, the first comparing unit 15 supplies the temperature data read command RC to the temperature data sampling unit 16. The temperature data sampling unit 16, having received the temperature data read command RC, acquires, as detected temperature data DT for the current time, a detection output from the speed reducer temperature sensor 3t in the robot 1 (Step S14).

Regarding obtainment of the detected temperature data DT in Step S14, it may be that, instead of this obtaining, an estimated value for the temperature of the mechanism section 4 at the current time calculated from a positional relationship on the time axis between operational and stop timings for the robot 1 is assigned as the detected temperature data DT, as described with reference to FIG. 4.

Next, the second comparing unit 17 compares a value for the detected temperature data DT obtained in Step S14 with the second threshold Th2 (Step S15). The second threshold Th2 is a lower limit for the temperature of a mechanism section among normal usage conditions for the robot 1. In a case where the value for the detected temperature data DT is less than the second threshold Th2 as a result of this comparison (Step S15: YES), the second comparing unit 17 supplies the display control command Dcc to the display unit 18. The display unit 18 displays information that corresponds to the display control command Dcc (Step S16). Display by the display unit 18 in Step S16 is, for example, a display with the gist that it is possible for issuance of an alarm to be due to a decrease in air temperature (a decrease in the temperature of the mechanism section), a display recommending warm-up operation which serves as a message prompting improvement of an operation condition, or the like. After the process in Step S16, the process in FIG. 5 ends.

In contrast, in a case where the value for the detected temperature data DT is equal to or greater than the second threshold Th2 as a result of the comparison in Step S15 (Step S15: NO), the second comparing unit 17 supplies the display control command Dcc to the display unit 18. Content for the display control command Dcc in this case differs to the case where the value of the detected temperature data DT is less than the second threshold Th2. In response to such a display control command Dcc, the display unit 18 displays information (Step S17). A display by the display unit 18 in Step S17 is, for example, a display that the air temperature (temperature of the mechanism section) is within a range for a normal usage condition for the robot 1, or the like. After the process in Step S17, the process in FIG. 5 ends.

A summary is given next regarding effects held by the control device 10, which is for an industrial machine, is according to the present disclosure, and was described with reference to FIG. 1 through FIG. 5 above.

(1) The control device 10 for an industrial machine according to the present disclosure includes: the control deviation acquisition unit 13 that acquires a control deviation CD pertaining to motion by a predetermined mechanism section 4; a temperature information acquisition unit (the temperature data sampling unit 16) that acquires temperature information (detected temperature data DT) for the mechanism section 4 in a case where the control deviation CD obtained by the control deviation acquisition unit 13 is greater than the predetermined first threshold Th1; a comparing unit 17 that compares a value in accordance with the temperature information obtained by the temperature information acquisition unit (the temperature data sampling unit 16) with the predetermined second threshold Th2; and an alarm information output unit (display unit 18) that, in a case where the value in accordance with the temperature information is less than the second threshold Th2, outputs alarm information including a message having a gist of prompting improvement of an operation condition.

The control device 10 for an industrial machine according to the abovementioned (1) typically stops at an alarm for an excessive control deviation being issued in a case where the control deviation CD pertaining to motion by the mechanism section 4 is greater than the first threshold Th1 and is excessive. With the control device 10 for an industrial machine according to the present disclosure, even in a case where an alarm is issued, when the temperature of a mechanism section is less than the second threshold Th2 and is outside of a normal usage condition, alarm information including a message prompting improvement of an operation condition is outputted from the alarm information output unit (the display unit 18). A user (operator) can recognize from this message that there is a situation in which improvement of the operation condition is necessary, and take an appropriate measure.

(2) In one aspect of the control device 10 for an industrial machine according to the present disclosure, the temperature information (the detected temperature data DT) obtained by the temperature information acquisition unit (the temperature data sampling unit 16) is a temperature of at least one of the motor 2 or the speed reducer 3 in the mechanism section 4.

With the control device 10 for an industrial machine according to the abovementioned (2), that a low-temperature state deviating from a normal operation condition and pertaining to at least one of the motor 2 or the speed reducer 3 in the mechanism section 4 has arisen is expressed by a message included in the alarm information from the alarm information output unit (display unit 18). A user (operator) can recognize this message and take an appropriate measure.

(3) In one aspect of the control device 10 for an industrial machine according to the present disclosure, the alarm information output unit (the display unit 18) outputs a message prompting warm-up operation as the message having the gist of prompting improvement of the operation condition.

With the control device 10 for an industrial machine according to the abovementioned (3), a user (operator) can take a measure for warm-up operation based on the message from the alarm information output unit (display unit 18) prompting warm-up operation.

(4) The control device 10 for an industrial machine according to the present disclosure is, in one aspect thereof, provided with the warm-up operation control unit 20 that, in a case where the value in accordance with the temperature information is less than the second threshold Th2, performs control to cause the mechanism section 4 to perform warm-up operation.

With the control device 10 for an industrial machine according to the abovementioned (4) a user (operator) can recognize that there is a situation in which warm-up operation is necessary, and warm-up operation starts up based on a control command from the warm-up operation control unit 20.

Accordingly, a load on the user (operator) is reduced.

(5) In one aspect of the control device 10 for an industrial machine according to the present disclosure, the temperature information acquisition unit (temperature data sampling unit 16) acquires the temperature information (detected temperature data DT) from a sensor (the motor temperature sensor 2t, the speed reducer temperature sensor 3t) installed in the mechanism section 4.

The control device 10 for an industrial machine according to the abovementioned (5) can obtain temperature information (detected temperature data DT) based on a real-time actual measurement value in accordance with the sensor installed in the mechanism section 4. Accordingly, there is accurate recognition regarding the temperature environment for the mechanism section 4, and it is possible to take an appropriate measure by relying on this recognition.

(6) In one aspect of the control device 10 for an industrial machine according to the present disclosure, the temperature information acquisition unit (the temperature data sampling unit 16) acquires the temperature information (detected temperature data DT) using estimation.

The control device 10 for an industrial machine according to the abovementioned (6) can obtain temperature information (detected temperature data DT) pertaining to the mechanism section 4 without being provided with a sensor or the like. Accordingly, configuration is simplified.

Note that the present disclosure is not limited to the above-described embodiment, and can be implemented with various modifications and changes. For example, the above-described embodiment has a configuration that is provided with each of the display unit 18 and the alarm issuing unit 19, but it is possible to have a configuration in which the display unit 18 and the alarm issuing unit 19 are integrated. In addition, it is also possible to use a wireless communication path instead of a wired communication path using cables to send and receive information (signals) between a control target (the mechanism section 4 in the robot 1) and the control device 10. In addition, the mechanism section 4 which is a control target is not limited to the mechanism section 4 in the robot 1 and a mechanism section typically in a machine tool or other industrial machine also corresponds thereto. In addition, modifications and improvements within a scope that can achieve the objectives of the present disclosure are also included in the present disclosure.

### EXPLANATION OF REFERENCE NUMERALS

1 Robot
2 Motor
2t Motor temperature sensor
3 Speed reducer
3t Speed reducer temperature sensor
4 Mechanism section
5 Encoder
6 Wrist section
7 Motion angle sensor
8 Cable
9 Cable
10 Control device (control device for industrial machine)
11 External connection terminal
12 Reference data generating unit
13 control deviation acquisition unit
14 Control command forming unit
15 First comparing unit
16 Temperature data sampling unit
17 Second comparing unit
18 Display unit
19 Alarm issuing unit
20 Warm-up operation control unit

1. A control device for an industrial machine, the control device comprising:
a control deviation acquisition unit configured to obtain a control deviation pertaining to motion by a predetermined mechanism section;
a temperature information acquisition unit configured to obtain temperature information for the mechanism section in a case where the control deviation obtained by the control deviation acquisition unit is greater than a predetermined first threshold;
a comparing unit configured to compare a value in accordance with the temperature information obtained by the temperature information acquisition unit with a predetermined second threshold; and
an alarm information output unit configured to, in a case where the value in accordance with the temperature information is less than the second threshold, output alarm information including a message having a gist of prompting improvement of an operation condition.

2. The control device for an industrial machine according to claim 1, wherein the temperature information obtained by the temperature information acquisition unit is a temperature of at least one of a motor or a speed reducer in the mechanism section.

3. The control device for an industrial machine according to claim 1, wherein the alarm information output unit outputs a message prompting warm-up operation as the message having the gist of prompting improvement of the operation condition.

4. The control device for an industrial machine according to claim 1, comprising a warm-up operation control unit configured to, in a case where the value in accordance with the temperature information is less than the second threshold, perform control to cause the mechanism section to perform warm-up operation.

5. The control device for an industrial machine according to claim 1, wherein the temperature information acquisition unit acquires the temperature information from a sensor installed in the mechanism section.

6. The control device for an industrial machine according to claim 1, wherein the temperature information acquisition unit acquires the temperature information using estimation.
